(19) United States
(12) Patent Application Publication
(10) Pub. No.: US 2017/0237787 A1
(43) Pub. Date: Aug. 17, 2017

(54) DATA SYSTEM CONFIGURATIONS FOR GENERATING PAGES

(71) Applicant: Samepage Labs Inc., San Jose, CA (US)

(72) Inventors: Egan Echeverría Schulz, San Jose, CA (US); Martin Viktora, Los Altos, CA (US); Eric Edward Weasner, Livermore, CA (US); Martin Hosna, Pilsen (CZ); Pavel Benes, Pilsen (CZ); James A. Ringham, San Jose, CA (US); Jan Jezek, Pilsen (CZ)

(21) Appl. No.: 15/426,546

(22) Filed: Feb. 7, 2017

Related U.S. Application Data
(60) Provisional application No. 62/296,061, filed on Feb. 16, 2016.

(51) Int. Cl. H04L 29/06; G06F 3/0483; G06F 17/30; H04L 12/58

(52) U.S. Cl. CPC H04L 65/403; H04L 51/04; H04L 51/16; H04L 51/34; G06F 3/0483; G06F 17/30864; G06F 3/04842

(57) ABSTRACT

Various systems, mediums, and methods herein describe aspects of presentations of information from several different sources. In one implementation, a data system may generate a page and provide a plurality of users with access to the page. The page is configured to be modified by the plurality of users. The system may also determine a page view of a given user from the plurality of users and respective page views of other users from the plurality of users. The page view of the given user comprises at least a portion of the page; the respective page views of the other users are outside of the page view of the given user. The system may further provide in the page view of the given user an indication of at least one respective view of the respective views of the other users.

### RELATED APPLICATION

This application claims the benefit of U.S. Provisional Patent Application Ser. No. 62/296,061, filed Feb. 16, 2016, entitled “Data System Configurations For Generating Pages,” which is hereby incorporated by reference in its entirety.

### TECHNICAL FIELD

This disclosure generally relates to data system configurations for intelligently generating pages over various data networks.

### BACKGROUND

Users commonly face challenges with searching for information on their personal computing devices. For example, consider a scenario where a user is searching for specific information, such as the current status of a project, possibly to discuss on a conference call scheduled in the next few minutes. The user may begin searching through old emails scattered throughout multiple browsers opened on the user's laptop computer. After some time without the desired results, the user may then revert to searching through previous meeting notes and task lists on the user's smartphone. As such, the user may find herself on an on-going search for the information amongst various applications opened on multiple devices, thereby wasting valuable time that could be better spent on preparing for the meeting.

Further, consider another scenario where the user needs to get up to speed for the conference call or up-to-date regarding matters planned to be discussed on the conference call. As such, the user may begin scanning through multiple emails in a given inbox on the laptop computer to try and quickly refresh her memory on what projects have been completed and what projects are still pending. The user may also search message histories on messaging applications on the smartphone to try and understand what information has been exchanged. The user may then revert back to the laptop computer to search through multiple folders to try and locate files relevant to the meeting topics. In this manner, the user may also find herself on an on-going search, thereby wasting valuable time.

As such, searching for information across various such applications on multiple computing devices may be cumbersome and time-consuming. As demonstrated in the scenarios above, the user might be late for the call due to unproductive searches performed across the various applications on the multiple devices. As a result, the user may attend the call without having the particular information needed to intelligently discuss matters. Therefore, there is much need for technological advancements to support users in various situations, such as those described herein.

### BRIEF DESCRIPTION OF THE DRAWINGS

FIG. 1A shows an example data system for generating a page on a user device, according to an embodiment.

FIG. 1B shows an example data system for indicating a user presence outside a current view on a page displayed on a computer device, according to an embodiment.

FIG. 1C shows an example data system for indicating a user presence outside a current view on a page displayed on a mobile device, according to an embodiment.

FIG. 2A shows an example data system for attaching a file to a chat, according to an embodiment.

FIGS. 2B-2C show an example data system for collapsing a chat thread, according to an embodiment.

FIGS. 3A-3B show an example data system for referencing a page in a chat, according to an embodiment.

FIGS. 4A-4D show an example data system for providing a pie check box, according to an embodiment.

Embodiments of the present disclosure and their advantages may be understood by referring to the detailed description provided herein. It should be appreciated that reference numerals may be used to illustrate various elements and/or features provided in the figures. Further, the figures may illustrate various examples for purposes of illustration and explanation related to the embodiments of the present disclosure and not for purposes of any limitation.

### DETAILED DESCRIPTION

Considering the various scenarios above, the data system configurations described herein may collect or aggregate data from various other systems and networks to intelligently provide pertinent data on a single page that may be accessed by multiple users through their personal devices. As such, the data may be retrieved from remote systems, networks, hardware, and/or software applications, among various other technological data storage mechanisms. For example, the data system may provide a single page that provides a chat with other team members, a geographical map showing the location of various events, calendars with team meetings and appointments, and multiple task lists, among multiple other applications, thereby facilitating a common medium of communication on a single page.

Retrieving data across such systems and networks may thereby resolve various challenges such as those discussed above involving users commonly searching for information across various applications on multiple user devices and/or facing challenges with getting current or up to speed on various topics.

In particular, to prepare for the conference call, the data system described herein may enable users to efficiently search and locate pertinent information, which may be specific to the user or the group, within a single page. In particular, the user can search on the single page by viewing chat history, documents, spreadsheet files, presentations, calendars, a geographical map, among other media and applications described herein. The search may be performed on a single page generated by the data system to facilitate the search efficiently and to locate the pertinent information without delays. As such, the system configurations that provide the single page reduce, diminish, and/or eliminate the need to conduct separate searches through various applications on multiple devices.

The various technologies described in the present disclosure may provide numerous technical advantages. Content can be more effectively collected, aggregated, organized, and presented for convenient user access. For example, users can communicate on the same page such that the collaboration takes place on a single page. Users may communicate without having to email each other back and forth. In particular, users may communicate without having to view an email application separately from the other applications being viewed. As a result, the users may also continue working without generating a large number of unread emails or from switching between different applications, messaging platforms, and/or content providers.

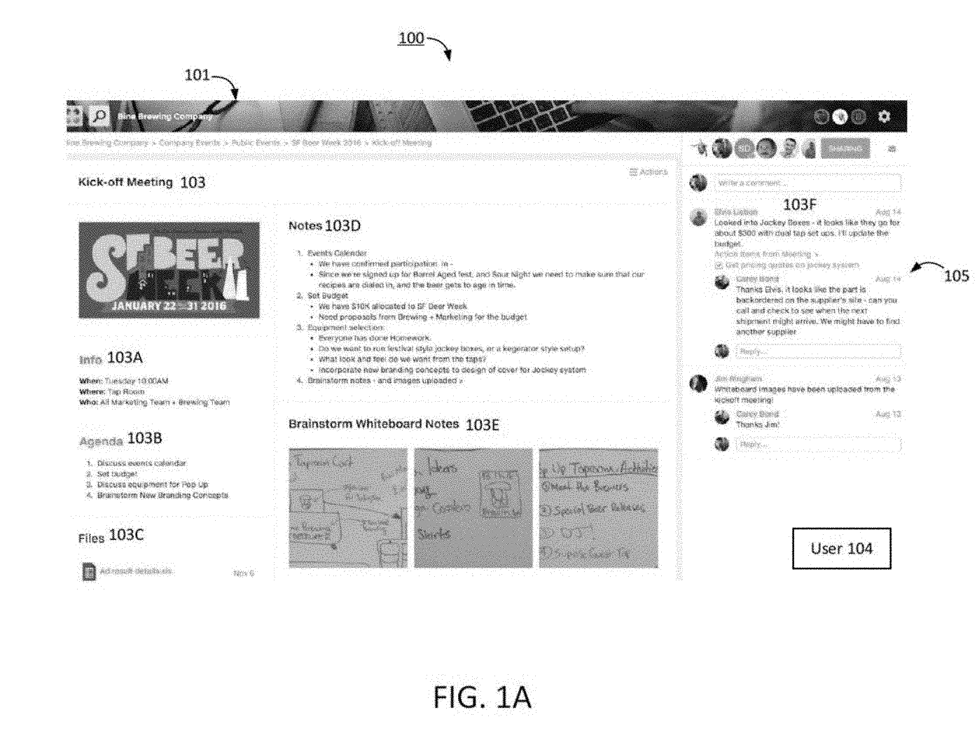

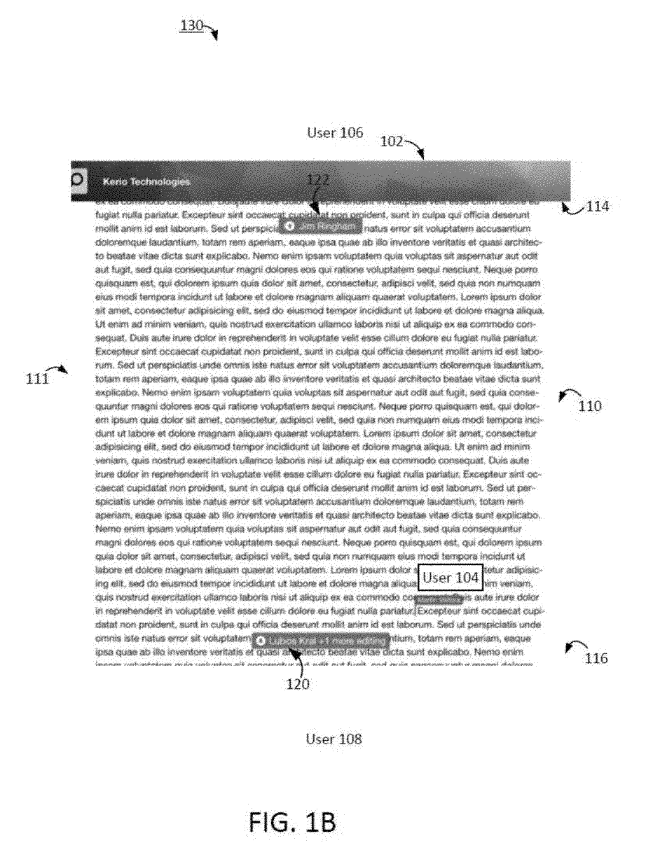

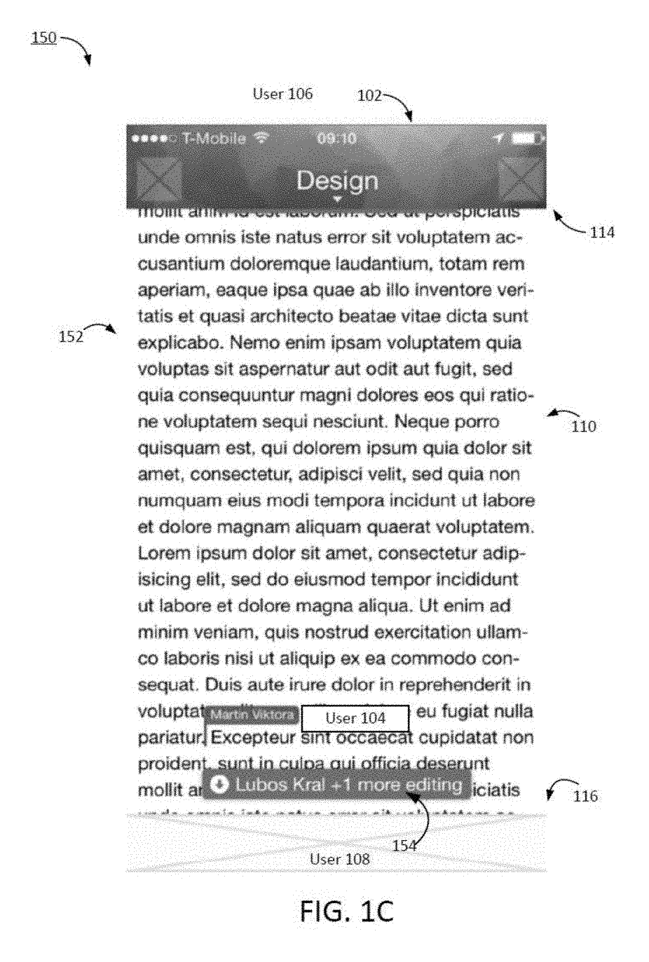

FIG. 1A shows an example data system 100 for generating a page 101 on a user device, according to an embodiment. As shown, the data system 100 may generate the page 101 to take the form of a webpage. The page 101 may include a page topic 103 (e.g., “Kick-off Meeting”), one or more pieces of information 103A (e.g., scheduling information) about the page topic 103, one or more agenda items 103B, one or more files 103C including spreadsheet documents, one or more text notes 103D, one or more non-text media 103E (e.g., photo, audio, video, or a combination of such media, among other types of medias), and a chat thread 103F which may include a number of instant-messages. Yet, the page 101 may include various other forms of data, such as voice and video to provide video-conferencing media streams.

In some embodiments, the system 100 generates the page 101 using content collected or aggregated from a server system, file system, an email system, a geographic positioning system (GPS), and an instant-messaging system, cloud networks, among other types of systems and networks. Further, in some embodiments, the page 101 is generated by a dedicated server or computer system that retrieves the data in real-time to display the page 101 to the various users through a web browser, a document editor, or any other types of content viewing applications. As such, the page 101 may be viewed from various computing devices, such as laptop computers, smartphones, wearable devices, and/or head-mountable displays, among other types of devices.

FIG. 1A also shows a page view 105 of or for the user 104. The page view 105 includes at least a portion of the page 101. The system 100 can determine the page view 105 based on one or more portions of the page 101 that are currently visually available to the user 104, without requiring the user to take any action. For example, the user 104 is able to view 105 the page 101 without having to scroll up or down to view the items 103A-103F. For example, as shown in FIG. 1, the page view 105 includes the content currently available to the user 104.

For another example, information from different sources can be visually coupled (e.g., linked) to ongoing user conversations (e.g., chats). A user may avoid having to go through a large number of materials from different applications and possibly across different devices to understand what has taken place. In some embodiments, a data system can generate such a page on a user device. In some instances, the page may take the form of a webpage.

A page may include member identifiers, such as user names or user group names. In particular, each identifier may represent one or more users associated with a page. The page may also include page membership information, which identifies one or more users who have been granted access to the page, such as for reading, writing, and/or collaborating. As such, a page member can view and/or edit content from the page, and/or collaborate with other users on a page. A page member (e.g., a page owner, a page administrator, a page publisher, a page super-user, or a page user) may have a predefined number of access privileges. Some access privileges are page level privileges, e.g., privileges involving page access management. Some access privileges are content level privileges, e.g., a user may not modify content in a calendar, but only view chat content. In some embodiments, a page may include information accessible by users with predefined privileges. For example, a page may include information accessible to page administrators, such as storage information and user access privileges.

A page can include user comments, e.g., page level comments (comments that may not relate to the page content, as well as content level comments (comments on a particular calendar entry included on a page). A page can include live content that may change based on real-time user input (e.g., a dynamic table that keeps growing or shrinking size-wise based on user inputs adding or removing table content). A page including live content is also referred to as a live page or a LivePage in the present disclosure.

In some embodiments, a live page may display a chat thread and page content on the same screen. In some embodiments, a LivePage may display page views by way of tabs, e.g., different views of a same page are available for user access under different page tabs. In some embodiments, a LivePage may automatically collapse or filter page content (e.g., a chat thread) without user intervention.

In some embodiments, a page may display indications (e.g., on-screen tips) as to what actions are available to a user on a particular content portion of the page. For example, when a user hovers over a calendar entry displayed on a page, a floating tooltip may be displayed to the user to indicate that the calendar entry may be moved, messaged to another user, trashed, or copy-and-pasted into another application.

A page may display information provided by multiple sources. In some embodiments, a page may include one or more data feeds, e.g., a news feed and a discussion feed. A user can roll up a data feed to aggregate the feed. In some embodiments, a page may include information identifying one or more events and display the events in different views, e.g., a compact view, a list view, and a calendar view. In some embodiments, a page may include information identifying one or more tasks, e.g., tasks assigned to or owned by a user.

A user can roll up task views as well. In some embodiments, a page may include a search shortcut, where a user can invoke a search using a predefined search engine or against a predefined data source. In some embodiments, a page may include references to other pages. In other words, a page may include nested pages. In some embodiments, a page may include one of more of the following content portions: a conversation, a nested page, text, a file, a cloud file, an image, an audio file, a video file, a table, a spreadsheet, a calendar, a task, a map, a link, a HTML content item, video streaming data for video conferencing, and/or a page level action. Thus, the page may be shared among several users. A page can be publically shared, e.g., shared with users who have the link.

In some embodiments, a user presence detection feature is provided. For example, a data system may detect the presence of one or more users on a page. Considering the scenarios above, the data system may detect that a user is viewing the page, possibly to search for particular information. Further, the data system may detect the presence of multiple users at different portions of the page. In particular, the data system may detect that the users are collaborating on the page. For instance, the users may be drafting or modifying a same document provided on the page.

In some embodiments, a user presence indication feature is provided. For example, a user may be viewing a page which other users are also accessing, albeit outside of the user's current field of view. As such, the data system may generate (e.g., visual) indicators (also referred to as indications in the present disclosure) on the page, e.g., at the top of the screen or bottom of the screen, to inform the user that other users are also accessing the page.

These indicators may inform not only the presences, but also the identities of other users accessing the same page. For example, the indicators may provide the names or other identifiers (e.g., usernames or system log-in names) of the other users accessing the page, possibly also including a hover feature. In particular, the given user may hover a pointer over the names or usernames of the other users to cause the page to provide more information about the other users, such as their email addresses, contact information, phone number, etc. Yet further, the hover feature may enable a chat between the given user and the other users.

In some embodiments, the indicators may be user-selectable. For example, an indicator may include a user-selectable button. In some instances, responsive to a user clicking the indicator button, the data system will cause the page to scroll up or down to the views of the other users. For example, a given user may be viewing the beginning of the document and yet a second user may be viewing the end of the document. The given user may select an indicator of the second user and the system may cause the page to scroll down such that the given user is viewing the end of the document with the second user. As such, the system provides the given user with the identities of the other users in the page and where the other users are in the page in relationship to given user's view or cursor placement. This can be done based on user interactions on specific portions of the page or through a camera or other visual sensing device that can track where the user is looking on a page. Further, the system provides convenient ways to jump to areas in the page to facilitate the collaboration with the other users. As noted, users may also initiate private chats or group chats directly from the indicators.

In some embodiments, the indicators may also provide miniature or reduced size views that correspond to the views of other users. For example, a given user may be collaborating or working towards the top of the page and a second user may be collaborating or working towards the bottom of the page. The system may generate an indication for the given user, possibly to inform the given user that the second user is working on the bottom of the page. Further, the system can show in the given user's view of the page a smaller view of the second user's view of the page towards the bottom of the document. The system may also detect language that the second user may be working on to identify that there may be a relationship with the language that the given user is working on. As such, the system may generate the miniature view based on the relationships detected.

FIG. 1B shows an example data system 130 for indicating a user presence outside a current view on a page displayed on a computer device, according to an embodiment. The system 130 may also take the form of the system 100 described above in relation to FIG. 1A. The system 130 generates the page 102 and provides a number of users 104, 106, and 108 with access to the page 102. The page 102 may also include portions of the page 101 described above. The system 130 involves a given user 104 viewing a page 102, where the user 104 has a view 110 of the page 102. Further, the system 100 indicates to the user 104 that one or more other users 106 and 108 are viewing the same page 102, where the other users 106 and 108 may be viewing portions of the page 102 that are outside the view 110 of the user 104.

The system 130 configures the page 102 such that the page 102 may be modified by a number of users 104, 106, and 108, where each user may have the same or different permissions. For example, the system 130 may enable one or more of the users 104, 106, and 108 to not only read, but also write and change (e.g., add, remove, and replace), content displayed on the page 102. For example, as shown in FIG. 1B, the system 130 may enable the user 106 to modify one sentence displayed on the page 102 and enable the user 108 to modify a different sentence on the page 102.

The system 130 may determine a page view 110 of the given user 104 from the other users 106 and 108. The page view 110 of the user 104 includes at least a portion 111 of the page 102. The system 130 can determine the page view 110 based on one or more portions 111 of the page 102 that are currently visually available to the user 104, without requiring the user 104 to take any action. In some embodiments, the portion 111 of the page 102 includes a subset or less than all content displayed on the page 102. For example, if the page 102 includes twenty paragraphs, the portion 111 of the page 102 may include five of these twenty paragraphs.

The system 100 may additionally determine respective page views 114 and 116 of other users 106 and 108 from the other users 106 and 108, respectively. As shown, the respective page views 114 and 116 of the other users 106 and 108 are outside of the page view 110 of the user 104.

The system 130 may also provide, in the page view 110 of the given user 104, an indication 120 of the views 114 and 116 of the other users 106 and 108, respectively. For example, as shown in FIG. 1B, the system 130 provides indications 120 and 122, which visually indicate to the user 104 that the users 106 and 108, respectively, are currently viewing or modifying one or more other portions of the page 102, which are not currently within the view 110 of the user 104.

These technical solutions are advantageous because when multiple users 104, 106, and 108 are collaborating on the same page 102, it may be beneficial to notify the user 104 that other users 106 and 108 are also accessing the page 102. For example, the user 104 changing one clause of a contract (e.g., redefining a word) may be acknowledged by the user 106, where the user 106 may be changing another part of the contract (e.g., using the redefined word), so that the changes from user 104 can be carried out throughout the page 102 by the other user 106.

In some embodiments, the system 130 can provide one or more indications 120 and 122 in the page view 110 at the same or different display locations. The total number of indications 120 and 122 provided may correspond to the number of other users 106 and 108 working on the same page 120, but outside the concurrent view 110 of the user 104.

For example, as shown in FIG. 1B, the system 100 may provide two indications: (1) the indication 122 displayed approximately at the top of the view 110 to indicate that the user 106 is currently accessing a portion of the page 102 that is above the view of the user 104, and the indication 120 displayed approximately at the bottom of the view 110 to indicate that the user 108 is currently accessing another portion of the page 102 that is below the view 110 of the user 104. In some embodiments, one or more of the indications 120 and 122 may be user-selectable. For example, indication 120 may be selected by the user 104 and the system 130 may replace the current view 110 of the user 104 with the view 116 of the user 108. For example, if the user 104 clicks on the indication 122, the view 110 may change to the view 114 of the user 106. These indications 120 and 122 are technically advantageous, because they provide not only visual cues as to the user presences and locations of the other users 106 and 108 accessing the same page 110, but also shortcut accesses to various content being viewed by those users 106 and 108. In some embodiments, the indication 120, when selected by the user 104, can invoke a private chat between the user 104 and the user 108.

In some embodiments, the system 130 may provide, in the view 110, pictures of the users 106 and 108. In some embodiments, the system 130 may provide mini-views of other users 106 and 108, such as when the other users 106 and 108 are accessing, e.g., viewing or modifying, content recognized as relevant to the user 104. For example, if the user 106 is using the redefined word of a contract displayed in the page 102, and the user 104 is drafting the definition of the redefined word, the system 100 may provide, to the user 104, a preview in a miniature view of the user 106's edits.

In some embodiments, one indicator may indicate the presence of two or more other users on the same page, e.g., to conserve display real estate. For instance, an indicator may visually represent that there are two or three other users accessing the same page which the user is also currently accessing, albeit outside the current view of the user. In some embodiments, an indicator's display location may suggest the relative location of another user to the current view of a given user. For example, an indicator displayed at the bottom of a user's current view may suggest that there is at least one other user accessing a portion of the page that is below the user's current view. Correspondingly, an indicator displayed on the top of a user's current view may suggest that there is at least one other user accessing a portion of the page that is above the user's current view. In some embodiments, indicators are displayed at predetermined locations. For example, the indication 122 is displayed at approximately the top of a user's view and the indication 120 is displayed at approximately the bottom of the user's view.

FIG. 1C shows an example data system 150 for indicating a user presence outside a current view on a page displayed on a mobile device, according to an embodiment. The system 150 can take the form of the system 100 and 130. As shown in FIG. 1C, the system 150 may display a portion 152 of the page 102. The portion 152 includes a subset, but less than all, of the content included in the page 102. The user 104 is accessing content displayed in the view 110. The users 106 and 108 are accessing content displayed in their respective views 114 and 116.

As shown in FIG. 1C, the system 150 may provide an indication 154 to visually indicate to the user 104 that the user 106 (as indicated by the phrase “Lubox Kral”) and one more other users (e.g., the user 108) are currently accessing (e.g., view or editing) content on the page 102. As also shown in FIG. 1C, the system 150 may provide one indication (e.g., the indication 154) to indicate the presence of two or more other users (e.g., the users 106 and 108), in order to conserve display real estate.

In some embodiments, the data system uses operational transformation to extend concurrent document editing capabilities to objects embedded in a page (or any other document).

Operational transformation (OT) may enable concurrent/collaborative editing of a page by multiple users at the same time. For example, changes made by users are formalized as a sequence of operations and transmitted to other users. On the receiving ends, the application of OT ensures that the resulting document is the same for all users.

An example algorithm for providing OT is as follows:

S represents the state of the document;

O represents an operation or sequence of operations, such as insert/format/delete a character performed on a state S;

N number represents the order of operations (O1, O2, . . . ON) and states (S1, S2, . . . SN);

F(S, O) represents a function which applies operation O on state S and produces a new state, such as F(S1, O1)=>S2, F(S2, O2)=>S3; and

OT(O1, O2) represents a function that performs OT on a given operation or a sequence of operations;

Changes O1 and O2 made by two users are reconciled to produce the same page as follows:
F(S1, O1)=>S2
F(S1, O2)=>S3
F(S2, OT((O2, N2), (O1, N1)))=>S4
F(S3, OT((O1, N1), (O2, N2)))=>S4

In some embodiments, OT is used for concurrent editing of a character-based page and to enable concurrent editing of objects embedded into the page. The embedded objects can have structured data representation.

These technologies enable many kinds of objects to be embedded into a page, such as an object representing a task (with data values like subject, due date, assigned to . . . ), events (name, date, description, location . . . ), and drawings (image vector data)

The embedded objects are stored in a page as if they were single characters, but a data system may use the “format” operation to store objects' data/properties. The format operation is key-value based, allowing for a single object to have multiple data values.

Using these technologies, the OT implementation layer does not need to understand the embedded objects data type and structure. The embedded objects are still treated as single characters but with their internal data controlled through format operations. A separate layer performs serialization and mapping of an object's data into format values.

The value can be of two types: atomic and nested OT. The atomic type represents the actual end value such as a number, string, date, etc. Concurrent changes to the atomic type work on a “last win” principle. The nested OT type represents a sub-document that is controlled by a separate OT. The main document and all sub-documents share a common change history.

In some embodiments, the data system may allow a user to reply specifically to a message among a number of messages included in a chat thread. For example, if a chat thread includes two discussion topics, a user can provide a reply specific to a message relating to one of the two topics. For example, if a user provides a comment to one message provided by another user in a chat thread, the other user can post a reply specific to the comment. These specific-reply technologies can allow a user to provide information specific to a certain portion of a chat, thereby reducing the burden on other users to keep track and understand the chat content. In some embodiments, the data system may allow a user to attach one or more files, or corresponding references thereto, to a chat thread.

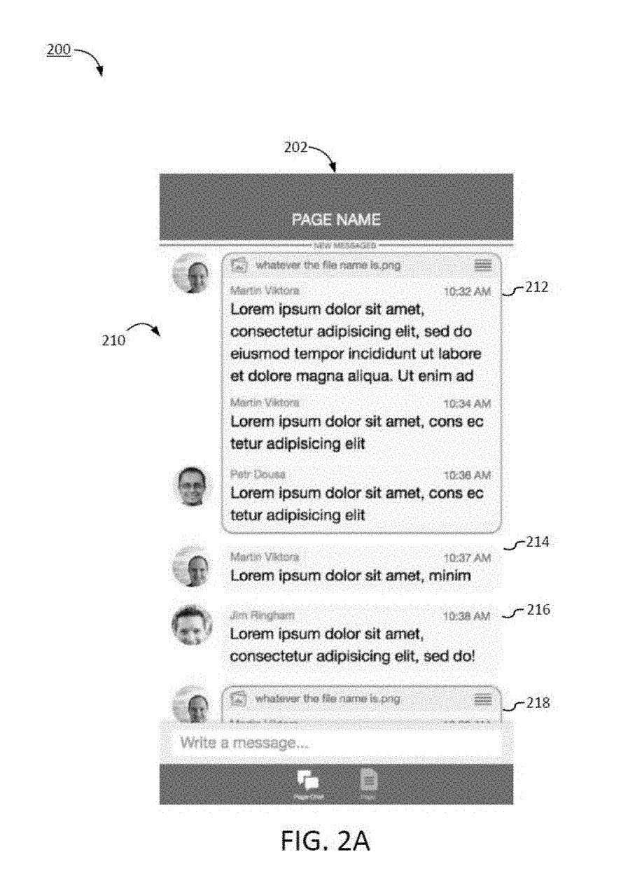

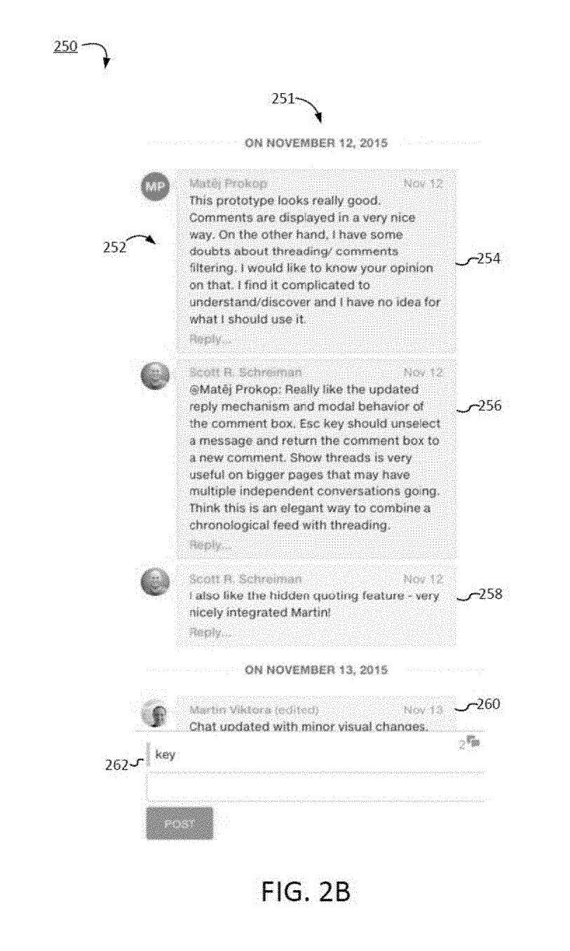

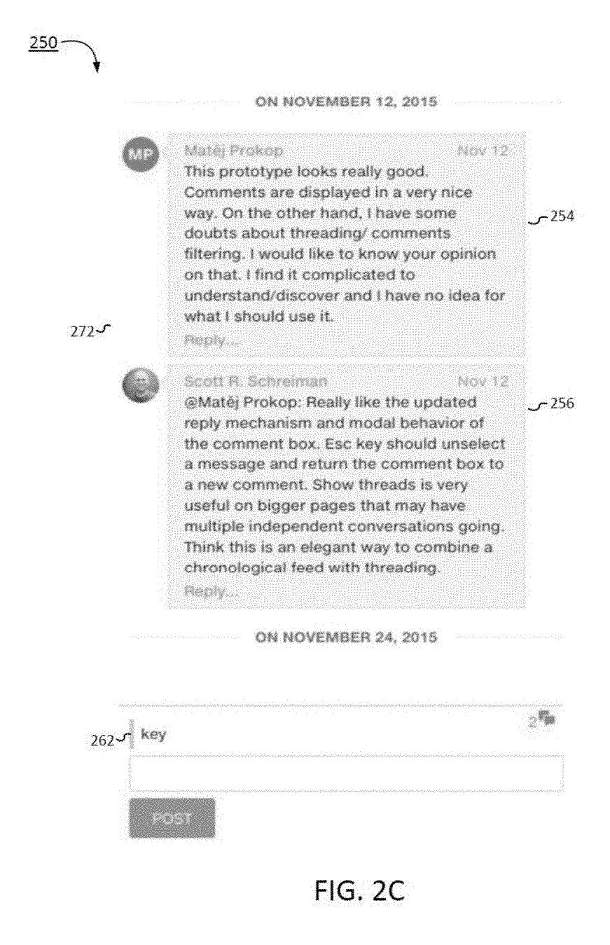

FIG. 2A shows an example data system 200 for attaching a file to a chat, according to an embodiment. The system 200 can take the form of the systems 100, 130, and 150.

In some embodiments, a page 202 may include a chat thread 210, which in turn includes a number of messages 212-218, e.g., instant-messages. The system 200 can display, on the page 202, a chat thread 210. The system 200 can display messages 212-218 included in the chat thread 210 in a chronological order based in part on when each individual message 212-218 is provided by a user.

The system 200 can also enable a user to attach one or more files to the chat thread 210. A file that can be attached to a chat thread may be a document, e., a plain-text document or a rich-text document. Yet further, in some instances, the file may include a webpage, a spreadsheet, a photo, a video clip, and/or a combination of such media, among other types of files described herein. For example, as shown in FIG. 2A, the message 218 included in the chat thread 210 is a photo attachment (named “whatever the file name is.png”).

In some embodiments, the data system may allow a user to collapse a chat thread. For example, the chat threat may include a large number of messages that may be collapsed into a reduced number of messages, e.g., for ease of user digest and future referencing. For example, for a chat that has been going on for days, weeks, or even months, there can be plenty of less relevant chat snippets (also referred to as individual messages in the present disclosure) within the overall conversation. Thus, by removing these less relevant chat snippets from the chat, the user can quickly understand the main points of the overall conversation and present the content in a more efficient and concise manner.

In some embodiments, the data system may provide a user interface (UI) control (e.g., a user-selectable button) that, when selected by a user, removes noise messages (e.g., messages that are not highly relevant to the overall them of the chat) and collapses relevant messages together (e.g., in a more compact view) so that it may be easier to not only remind an existing chat user (e.g., a chat participant) of what has been discussed in the chat, but also enable new chat users to bring themselves up to speed or get current about the main points of the chat.

In some embodiments, a user can reply to a specific chat message anywhere in a chat thread. A reply message can appear at the bottom (e.g., the beginning) of the chat thread, but will be connected as a conversation. In some embodiments, when a user hovers over a message in a chat thread, the system may display a user-selectable filter button to signal that the user can collapse the chat thread. In some embodiments, the data system can enable a user to quote text within a message. For example, a user can select text from a message, and the system may then display a reply button at a nearby location, e.g., for ease of enabling a user reply. In some embodiments, when a chat thread is in a collapsed mode or view, a user-provided message to the chat is deemed as a reply to the thread automatically.

FIGS. 2B-2C show an example data system 250 for collapsing a chat thread, according to an embodiment. The system 250 can take the form of the systems 100, 130, 150, and 200.

In some embodiments, responsive to a user request, the system 250 can collapse the chat thread 252 displayed on the page 251. For example, the chat thread 252 may have been going on for a predefined time period, e.g., several days, weeks, or months. The chat thread 252 may include a large number of individual messages 254-260, some of which are relevant to the overarching theme of the chat, and some of which are not (also referred to as noise messages in the present disclosure).

The system 250 may enable a user to conveniently remove, e.g., hide from display on the page 251, noise messages from a chat thread 252, and reorganize the display of relevant messages in the chat thread 252. These chat collapsing technologies enable a user to skip or skim less relevant messages within a potentially lengthy chat thread, thereby leaving the user more time to review and comprehend the main points of the chat. As a result, the user may require less time to bring herself up to speed, for example, in order to prepare for a meeting or a conference call. These technologies can therefore improve efficiency and conserve display real estate, compared to forcing the user to go through all or at least a larger number of messages in order to understand the main points. By conserving display real estate, computer functionality may be improved, such as power conservation or more efficient use of power.

In some embodiments, the system 250 collapses messages 258 and 260 in the chat thread 252 by identifying a chat message 254 from the plurality of messages 254, 256, 258, and 260 based at least on one or more words 262. Further, the system 250 may collapse the messages 258 and 260 in the chat thread 252 by identifying the one or more noise messages 258 and 260 from the plurality of messages 254-260 based at least on the chat message 254. Yet further, the system 250 may collapse the chat thread 252 based on the contents in the one or more noise messages 258 and 260. Additionally a user can select a “reply” button, thereby communicating to the system manually that the new message is related.

In some embodiments, a word 262, which is also referred to in the present disclosure as a keyword, may include one or more words, symbols, or a combination of these data, among other types of data. In some embodiments, a noise message 258 may be a message that is deemed by the system 250 as not relevant above a predefined threshold to a user-provided keyword 262. For example, a noise message 258 can be a message that does not include a user-provided keyword 262 or any of its synonyms. For example, the message “I like the prototype” can be considered a noise message because it does not include the user-provided keyword “project” or one of its synonyms (“task”).

In some embodiments, the system 250 can collapse a chat thread 252 by removing the identified noise messages 258 and 260 from the chat thread 252 and maintaining, in the chat thread 252, the display of the identified core messages 254 and 256. As shown in FIG. 2C, the system 250 has collapsed the chat thread 252 into the chat thread 272, which includes only messages 254 and 256.

In some embodiments, a data system can enable a user to add a page to a chat thread, e.g., a one-to-one chat, a one-to-many chat, or a page chat. After a reference to a page is added to a chat thread, every user in the chat thread can select the reference. A selection by a user of the reference can take the user to the referenced page. These page referencing technologies essentially “warping” users to the referenced pages without having to navigate to the referenced pages by following the actual hierarchy.

In some embodiments, the system 250 can enable a user to create a page or file reference in a chat thread. For example, after a user enters, in a chat thread, (1) a predefined symbol (e.g., “@”) or keyword (e.g., the word “at”) and (2) a page identifier (e.g., a page name “work page”), the system 250 may create a reference to the page (also called a page reference in the present disclosure) in the chat thread and enable other uses in the chat thread to access the page using the page reference. For another example, after a user enters, in a chat thread, a predefined symbol (e.g., “@”) and a file identifier (e.g., a file name “work_bio_photo.jpg”), the data system may create a reference to the file (also called a file reference in the present disclosure) in the chat thread and enable other uses in the chat thread to access the file using the file reference.

In some embodiments, a reference (e.g., to a page or a file) provides a dynamic link (e.g., to the page or the file). For example, after a reference to a page has been added to a chat, the data system 250 may keep track of the storage location of the page and update the reference, without requiring additional user action and simply based on the current storage location of the page. For example, once a reference to the “work” page is added to a chat thread, the data system 250 can periodically (e.g., every hour or day) or responsive to a triggering event (e.g., the “work” page is being moved) check the new location of the “work” page and update the reference to the “work” page without requiring the user to perform such updates. These auto-referencing technologies are advantageous because they reduce or eliminate the burden on a user to maintain page or file references, thereby saving on device memory.

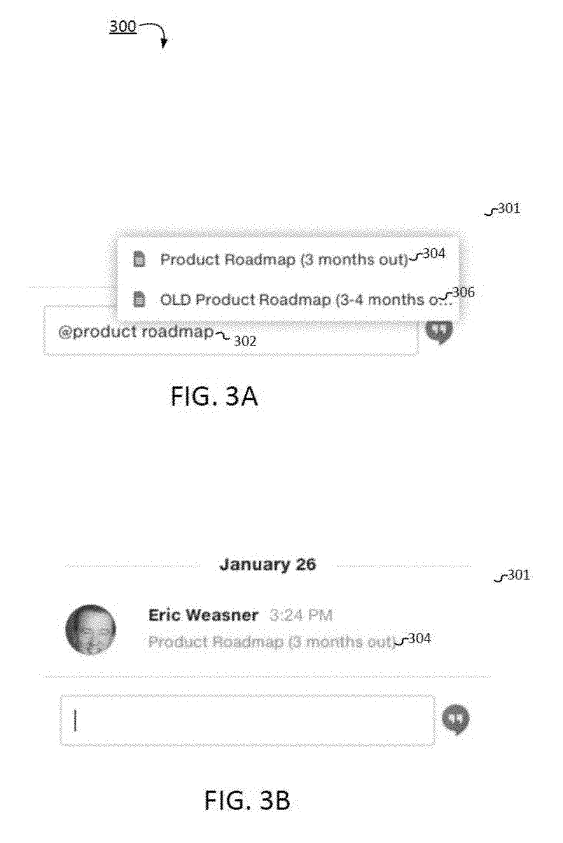

FIGS. 3A-3B show an example data system 300 for referencing a page in a chat, according to an embodiment. The system 300 can take the form of the systems 100, 130, 150, 200, and 250.

The system 300 may provide, in a chat 301, a reference 304 to the page that corresponds to an at-sign (e.g., the “@” symbol) and at least one word, e.g., a user-provided keyword. The system 300 may provide the reference 304 based on determining a selection of the at-sign and the at least one word 302 and provides a page based at least on the selection of the at-sign and the at least one word 302.

As shown in FIG. 3A, responsive to detecting that a user has provided (1) an at-sign (the “@” symbol) and (2) a keyword (“product roadmap”) 302 in the chat 301, the system 300 may provide to the user several candidate references 304 and 306 (e.g., hyperlinks or other shortcuts) to other existing pages.

As shown in FIG. 3B, after the user selects the page reference 304 (also referred to as a page mention in the present disclosure) from the candidate page references 304 and 306, the system 300 may display the selected page reference in the chat 301. These page referencing technologies enable a user to more quickly access other pages within a chat thread displayed on a current page.

In some embodiments, a data system 300 can provide a UI control that not only enables a user to provide information about a particular portion of page content (e.g., a task displayed on a page), but also illustrates the current status of the portion of the page content (e.g., the completion status of the task). For example, the data system 300 may provide a checkbox that carries more than merely an on or off status or a not-check/checked status. The checkbox may carry multiple (e.g., more than two) statuses. For example, the data system may provide a checkbox that has five user-selectable statues (e.g., 0%, 25%, 50%, 75%, and 100% complete).

In some embodiments, a pie checkbox feature is provided. A pie checkbox may appear like a miniature pie chart that not only is user-selectable and but also changes its visual appearance based on a user selection. For example, a pie checkbox may start with no filling or a minimal amount of filling when a user indicates that the task or project presented by the checkbox has not started; the checkbox may become gradually filled (or colored) when a user indicates that the task or projects presented by the checkbox is being worked on towards completion; and the checkbox may be fully filled (e.g., have a solid filing) when a user indicates that the task presented by the checkbox has been finished.

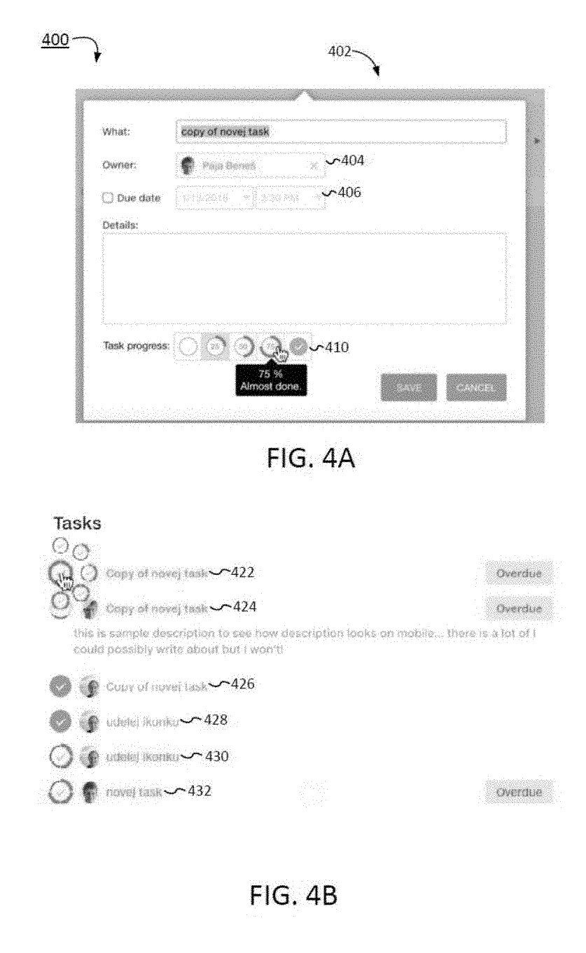

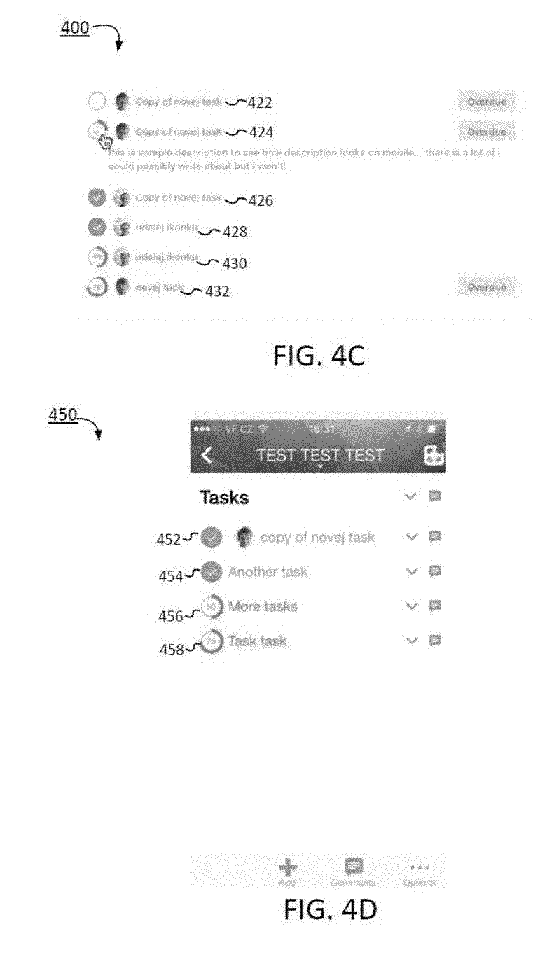

FIGS. 4A-4D show an example data system 400 for providing a pie check box, according to an embodiment. The system 400 can take the form of the systems 100, 130, 150, 200, 250, and 300. The system 400 may generate a page and create one or more pie check boxes configured to indicate a percentage completion of a given task.

As shown in FIG. 4A, the system 400 can enable a user to create a task 402 and further enable the user to assign, to the task 402, an owner 404, optionally other information, such as a due date 406, a description 408, and a current completion status 410. The current completion status 410 of the task 402 can be assigned by way of selecting a corresponding pie check box among a number of pie check boxes. As tasks are created and assigned, the system 400 may also display and enable a user to update current statuses of a created tasks 422 in view of their respective due dates (if any).

FIG. 4B shows how the system 400 may enable a user to update a status of a task 422 in a rollup view. As shown in FIG. 4B, the system 400 can enable a user to update the status of the task 422 as 100% completed by selecting a corresponding pie check box. As also shown, the system 400 may enable a user to update the statuses (e.g., percentages) of the other tasks 424, 426, 428, 430, and 432.

FIG. 4C shows how the system 400 may enable a user to update a status of a task 424 in a compact view, e.g., on a mobile device or a device that has a reduced display real estate.

FIG. 4D shows how the system 400 may display tasks 452, 454, 456, and 458 and their respective completion statuses on a page 450.

In some embodiments, the data system 400 may enable a user to drag an object displayed on a page to a map displayed on the same page (or a different page). These drag-and-drop technologies can associate objects displayed on a page, e.g., a task, an event, and a graph, to corresponding locations on the map at which the objects are dropped, thereby automatically (without requiring user interventions additional to the drag-and-drop actions) providing location information to the objects.

For example, after determining that a user has dragged a meeting appointment from an appointment column of a page to a location named “Palo Alto” on a map displayed on the page, a data system may select “Palo Alto” as the location of the meeting. For another example, after determining that a user has dragged a task from a task column to an area corresponding to the City of San Francisco on a map displayed on the page, the data system may assign the task to all users having the work location “the City of San Francisco.”

In some embodiments, a data system can associate GPS data from the map with various types of content in a data model. For example, a user could add images relevant to an event on the map so other users can easily identify what event is being held and where the event is being held, without searching through emails.

In some embodiments, the system 400 may also generate a page that includes a geographic map. The system 400 may identify an object that is moved (e.g., from another location on the page) to the geographic map; and generating content on the geographic map based at least on one factor describing movement of the object to the geographic map.

In some embodiments, a page may include a number of messages, and the system 400 may track a message sent by a given user that is not responded to by other users and provide, on the page, an indication that corresponds to the message sent by the given user.

In some embodiments, a page recovery (or reverting) feature is provided. For instance, a data system can create duplicates of a page at a given time point and provide a user interface (UI) control (e.g., a sliding bar) for reverting a page to any number of time points for which a page duplicate exists. The system may also mark page duplicates at different time points as different versions, thereby providing a strong versioning feature. These page recovery technologies can allow a user to not only recover a page from a page history, but also see how a page has developed or been modified over a given period of time.

In some embodiments, a data system may allow a user to create a duplicate of a page at any given time and designate that given time as a time origin for page recovery purpose. In some embodiments, the data system can automatically, without requiring user intervention, create a duplicate of a page, responsive to a triggering event (e.g., a substantial change has been made to a content portion included in a page), at any given time and designate that given time as a time origin.

The system 400 may determine a page generated at a given time from a plurality of times associated with a page history and revert the page back to the given time based at least on an instruction to view the page at the given time.

For example, the system 400 may provide a slider that allows a user to quickly identify a time point in the past and revert a page back to the identified time moment. The system 400 may allow a user to, at any time point, create a duplicate of a page as existed as that time point.

In some embodiments, a data system can keep track of “addressed-but-not-yet-replied-to” messages. Currently, users communicate with each other, e.g., by way of emails or chats, or both, all day long. Sometimes, a user may not know whether she has received a reply to an earlier message of hers.

In some embodiments, a data system may provide a folder (or a designated area on a page) in which a user can review messages that have been addressed, viewed, and/or responded by the user. For example the data system may provide an inbox folder to include (1) chat messages in which the user was specifically mentioned (e.g., by way of the “@” sign) but to which user has not replied, (2) emails in which the user was the primary recipient (as opposed to being CC′d or BCC′d) but to which user has not replied, or (3) files that have been shared with the user.

The data system may additionally generate alerts for when a message has not been responded to for a predefined threshold time period (e.g., 5 days) or based on other triggering events. In some embodiments, all communications in which a user has been addressed may be displayed in this “addressed-but-not-yet-replied-to” as soon as they are received and may then be removed when a response happens.

In some embodiments, an express reply may be needed to remove a message from being deemed as “not-yet-replied-to.” For example, a user may need to affirmatively reply to message, e.g., typing at least one word and providing the at least one word in a chat, in order for the data system to remove the message from the “addressed-but-not-yet-replied-to” folder. In some embodiments, an implicit reply may suffice to remove a message from being deemed as “not-yet-replied-to.” In other words, a user action with respect to a message can be deemed as an implied reply to the message.

For example, the data system may deem a message as having been replied to if a message recipient forwards the message to a third user (even without specifically replying to the message sender), when the message includes keywords such as “please forward,” “no reply is necessary,” or the like. For a further example, the data system may deem a message as having been replied to if a message recipient begins or resumes working on a task described in the message. In some embodiments, the data system, after detecting an implicit reply, may notify the original sender that “the recipient is working on it” or the like.

In some embodiments, the data system will not deem a message as “not-yet-replied-to” until a predefined time period (e.g., an hour) has been passed since a message recipient is known to be or become available to reply to messages. For example, the data system may check a message recipient's calendar, an appointment log, or a combination of these sources where user availability (or lack thereof) may be ascertained to determine whether the recipient is or has become available to reply to messages.

For example, the data system may deem a message “not-yet-replied-to” only after half an hour has passed after a user's last meeting or other appointments (during which the user is deemed by the data system as unavailable for message reply). These technologies can reduce false alert situations where a user is known to be unavailable for a particular time period, and thus generating a large number of reply reminders during that time period may be unnecessary, but in fact burdensome, to the user.

In some embodiments, the system 400 may keep track of a user's “addressed” communications and saves copies of or references to these communications in an area, e.g., a file folder, in a page. A user can go to the area and review all the addressed messages that have not yet been responded to.

The system 400 may generate, in the area, references to communications (e.g., instant-messages, emails, tasks, and appointment) addressed to a user, and remove the references when the user responds to the corresponding communications.

In some embodiments, a data system can provide an open architecture interface (API) to some of its internal function calls, subroutines, and parameters. Through the API, other external application can communicate with the data system and plug-ins can be built to be part of the data system.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a user could be termed a second user, and, similarly, a second user could be termed a first user, without changing the meaning of the description, so long as all occurrences of the “first user” are renamed consistently and all occurrences of the “second user” are renamed consistently. The first user and the second user are both users, but they are not the same user.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

1. A data system, comprising:
a non-transitory memory; and
one or more hardware processors configured to execute instructions to perform operations comprising:
generating a page;
providing a plurality of users with access to the page, wherein the page is configured to be modified by the plurality of users;
determining a page view of a given user from the plurality of users, wherein the page view of the given user comprises at least a portion of the page;
determining respective page views of other users from the plurality of users, wherein the respective page views of the other users are outside of the page view of the given user; and
providing in the page view of the given user an indication of at least one respective view of the respective views of the other users.

2. The data system of claim 1, wherein the page generated comprises a chat thread comprising a plurality of messages, and wherein the operations further comprise:
identifying a chat message from the plurality of messages based at least on one or more words;
identifying one or more noise messages from the plurality of messages based at least on the chat message; and
collapsing the one or more noise messages.

3. The data system of claim 1, wherein the page generated comprises a geographic map, and wherein the operations further comprise:
identifying an object that is moved to the geographic map; and
generating content on the geographic map based at least on one factor describing movement of the object to the geographic map.

4. The data system of claim 1, wherein the page generated comprises a plurality of messages, and wherein the operations further comprise:
tracking a message sent by the given user that is not responded to by the other users; and
providing, on the page, an indication that corresponds to the message sent by the given user.

5. The data system of claim 1, wherein the operations further comprise:
determining the page generated at a given time from a plurality of times associated with a page history; and
reverting the page back to the given time based at least on an instruction to view the page at the given time.

6. The data system of claim 1, wherein the page generated comprises one or more pie check boxes configured to indicate a percentage completion of a given task.

7. The data system of claim 1, wherein the page corresponds to an at-sign and at least one word, and wherein the operations further comprise:
determining a selection of the at-sign and the at least one word, wherein the page is generated based at least on the selection of the at-sign and the at least one word.

8. A non-transitory machine-readable medium having stored thereon machine-readable instructions executable to cause a machine to perform operations comprising:
generating a page;
providing a plurality of users with access to the page, wherein the page is configured to be modified by the plurality of users;
determining a page view of a given user from the plurality of users, wherein the page view of the given user comprises at least a portion of the page;
determining respective page views of other users from the plurality of users, wherein the respective page views of the other users are outside of the page view of the given user; and
providing in the page view of the given user an indication of at least one respective view of the respective views of the other users.

9. The non-transitory machine-readable medium of claim 8, wherein the page generated comprises a chat thread comprising a plurality of messages, and wherein the operations further comprise:
identifying a chat message from the plurality of messages based at least on one or more words;
identifying one or more noise messages from the plurality of messages based at least on the chat message; and
collapsing the one or more noise messages.

10. The non-transitory machine-readable medium of claim 8, wherein the page generated comprises a geographic map, and wherein the operations further comprise:
identifying an object that is moved to the geographic map; and
generating content on the geographic map based at least on one factor describing movement of the object to the geographic map.

11. The non-transitory machine-readable medium of claim 8, wherein the page generated comprises a plurality of messages, and wherein the operations further comprise:
tracking a message sent by the given user that is not responded to by the other users; and
providing, on the page, an indication that corresponds to the message sent by the given user.

12. The non-transitory machine-readable medium of claim 8, wherein the operations further comprise:
determining the page generated at a given time from a plurality of times associated with a page history; and
reverting the page back to the given time based at least on an instruction to view the page at the given time.

13. The non-transitory machine-readable medium of claim 8, wherein the page generated comprises one or more pie check boxes configured to indicate a percentage completion of a given task.

14. The non-transitory machine-readable medium of claim 8, wherein the page corresponds to an at-sign and at least one word, and wherein the operations further comprise:
determining a selection of the at-sign and the at least one word, wherein the page is generated based at least on the selection of the at-sign and the at least one word.

15. A method, comprising:
generating a page;
providing a plurality of users with access to the page, wherein the page is configured to be modified by the plurality of users;
determining a page view of a given user from the plurality of users, wherein the page view of the given user comprises at least a portion of the page;
determining respective page views of other users from the plurality of users, wherein the respective page views of the other users are outside of the page view of the given user; and
providing in the page view of the given user an indication of at least one respective view of the respective views of the other users.

16. The method of claim 15, wherein the page generated comprises a chat thread comprising a plurality of messages, and further comprising:
identifying a chat message from the plurality of messages based at least on one or more words;
identifying one or more noise messages from the plurality of messages based at least on the chat message; and
collapsing the one or more noise messages.

17. The method of claim 15, wherein the page generated comprises a geographic map, and further comprising:
identifying an object that is moved to the geographic map; and
generating content on the geographic map based at least on one factor describing movement of the object to the geographic map.

18. The method of claim 15, wherein the page generated comprises a plurality of messages, and further comprising:
tracking a message sent by the given user that is not responded to by the other users; and
providing, on the page, an indication that corresponds to the message sent by the given user.

19. The method of claim 15, further comprising:
determining the page generated at a given time from a plurality of times associated with a page history; and
reverting the page back to the given time based at least on an instruction to view the page at the given time.

20. The method of claim 15, wherein the page generated comprises one or more pie check boxes configured to indicate a percentage completion of a given task.
